(19) United States
(12) Patent Application Publication
(10) Pub. No.: US 2016/0125628 A1
(43) Pub. Date: May 5, 2016

(54) GEOGRAPHICAL INFORMATION SYSTEMS

(71) Applicant: GeoloGIS Ltd., Gordon (GB)

(72) Inventor: Rob BARNES, Gordon (GB)

(21) Appl. No.: 14/533,514

(22) Filed: Nov. 5, 2014

(51) Int. Cl. G06T 11/20; G06F 17/30; G06K 9/00

(52) U.S. Cl. CPC G06T 11/20; G06K 9/00476; G06F 17/30241

(57) ABSTRACT

A digital map is provided with information vertex data structures each storing a location, one or more attributes of the space at that location, and a line identifier; and a plan representing a space and comprising a line drawn on the plan between points corresponding to the locations of a plurality of information vertex data structures. The map provides a bespoke, GIS-based geoscience software system that may include several fully integrated and dynamically linked components to better serve both the geoscientist and data user communities. A bespoke database model coupled with a new method of data attribution allows the full variety and complexity of geoscience data and interpretation to be captured.

### CROSS-REFERENCE TO RELATED APPLICATIONS

The present disclosure relates to geographical information systems (GIS) software, and in particular to new digital GIS products with expanded information capture and visualization capability driven by, but not restricted to, the use of GIS in geology and geoscience.

### BACKGROUND

‘Geology’ may be defined as the physical substance and structure of the Earth (or any other planetary body) and ‘geoscience’ as the process of research and investigation leading to an understanding and description of the Earth's geology. However, because the Earth is an active and changing system (albeit on a ‘geological’ timescale), geoscience also seeks to understand geological history and processes to provide insight into ongoing and future evolution.

For the purposes of this document we refer to our knowledge and understanding of the composition of that part of the Earth's surface that influences our lives, typically the top few meters to a few kilometers in depth. This ‘near surface’ zone is of fundamental importance to much of our modern world from sustainable sources of natural materials including water through the safety of the natural and built environment to the safe disposal of toxic wastes.

Developed over the last two centuries the geological map is the fundamental method of interpreting and communicating geological information. Such mapping is usually provided by national geological surveys but may incorporate maps and other information from a wide range of sources including research, mineral investigation and engineering and construction activities. The map is an interpretation of the geoscientific knowledge and the geological information available at the time that it was produced. With advances in one or both of these factors it becomes necessary to revise and republish the maps depending on need.

The production of geological mapping was, until the mid-20^{th} century, completed by hand by the geologist or by specialized cartographers using traditional map drafting methods. The process has since been revolutionized in many countries by the emergence and rapid evolution of digital technologies using a range of different software products: paper data records are progressively being replaced with electronic databases and maps drawn digitally using computer aided design (CAD) software although geologist drawn primary products and the printed paper products remain important. Change is progressing however with the relatively recent adoption of geographical information systems (GIS) software that in principal encapsulates both database and CAD capabilities. Ideally the use of this genre of software has the potential to facilitate all stages of map production from geologist working maps to final user-focused products digitally within a single software product, whilst creating GIS maps that could carry and convey far more information that the precursor paper products.

However, the extent to which this change is possible using current GIS products is severely restricted in several respects by the limitations of the software and the underlying data model. It is necessary therefore, as a matter of some urgency, to create a GIS version that is specifically designed for geoscientific purposes and accessible worldwide. Limitations include:

1. Geological maps are complex drawings requiring considerable skill and precision in drafting; the way in which drawings are constructed in GIS is cumbersome compared with modern cartographical or CAD products, making map drafting in GIS relatively laborious and prone to error.

2. Classification and description of objects in GIS is inflexible and severely limited by the GIS data structure; for geological purposes this does not allow the capture or visualization of the variety and complexity of the information available and necessary to realize a comprehensive, informative product.

3. Geological plans are used at widely different scales, previously requiring redrafting to create several printed map series; even in GIS these different versions of the plan must be redrawn to simplify the content as necessary for use at progressively smaller scales. Ideally this scale transition must be facilitated automatically from a single drawing.

A further drawback in the use of GIS software for geological mapping is that components of the map other than the map's plan itself are difficult or impossible to replicate within the GIS environment. A simple legend describing the colors or symbols used can be provided by most GIS products but the capability is generally wholly inadequate to convey the more complex information required of geological legends. Other specialized non-plan components such as cross sections and various specialized forms of graphical presentation also cannot easily be created. In practice at present these important elements of the map must be prepared using other means and published as printed or pdf documents in support of the GIS plan or, as is commonly the case, such components are no longer provided.

One of the potential advantages in the use of GIS for the preparation and presentation of geological mapping is the possibility that regular map revision required by new data and/or changes in scientific understanding can be replaced by a system of ‘continuous revision’ in which parts of the map can be updated as necessary. In practice, however, the limitations of currently available GIS products make this less rather than more likely.

In this disclosure we address these and other deficiencies of extant GIS software. A new bespoke data model is designed to allow realization of full geological map drafting and visualization capability. Further advantages and features may also be derived from the present disclosure.

### SUMMARY

According to a first aspect of the disclosure there is provided a digital map comprising: a plurality of information vertex data structures each storing a location, one or more attributes of the space at that location, and a line identifier; and a plan representing a space and comprising a line drawn on the plan between points corresponding to the locations of a plurality of information vertex data structures.

A plan is a diagrammatic representation of any space, real or imagined. The space may be the earth's surface or a portion of it; or of sub-surface regions of the earth.

Optionally, the digital map further comprises a plurality of graphical vertex data structures, each storing a location and a line identifier.

Optionally, a line is drawn on the plan between points corresponding to the locations of a plurality of information vertex data structures and a plurality of graphical vertex data structures.

Optionally, the number of graphical vertex data structures used in the construction of a line drawn on a plan varies with a scale of the plan.

Optionally, the line is plotted on the plan using the information vertex data structures and additional graphical vertex data structures are placed either manually or automatically according to a mathematical function.

Optionally, the information vertex data structures each store an attribute that defines a relative degree of importance or scale range within which they are applicable.

Optionally, a line drawn on a plan having a first scale is drawn between points corresponding to all the plurality of information vertex data structures, and a similar line drawn on a plan having a second scale is drawn between points corresponding to a selection of the plurality of information vertex data structures, wherein the second scale is smaller than the first scale and the selection of information vertex data structures is made on the basis of their stored relative degrees of importance or scale range classification.

Optionally, variations in a drawn line can be edited retrospectively by selecting the necessary vertex data structures and changing their attribution.

Optionally, previous versions of lines are stored so that the evolution of a line over time can be traced.

Optionally, the digital map comprises a polygon drawn on the plan and created automatically from one or more lines drawn on the plan.

Optionally, polygon fill data is included as one or more of the attributes stored in an information vertex data structure.

Optionally, a dedicated information vertex data structure is provided which stores polygon attribute values or links to a legend structure.

Optionally, the plan location of the dedicated information vertex data structure is within the area of the polygon.

Optionally, one or more attributes of an information vertex data structure comprises a representation of confidence of the accuracy of one or more of the attributes stored in the vertex data structures.

Optionally, the representation of confidence of the accuracy of one or more of the attributes comprises a classification.

Optionally, the representation of confidence of the accuracy of one or more of the attributes comprises an integer value.

Optionally, the attributes for which a representation of confidence of accuracy is stored comprise one or more selected from a group including: x and y plane position, height, age, dip, thickness, younging (“way up”), age of a geological unit, type of a geological unit, general confidence of a geological unit, type of a geological line, general confidence of a geological line, general confidence that a line represents a surface, age of a geological surface, dip of a geological surface, type of a geological surface, thickness of a geological surface, general confidence of a geological surface.

Optionally, the digital plan further comprises a digital legend data structure for displaying a digital legend.

Optionally, wherein attributes of the space are stored in the digital legend data structure.

The space may comprise the polygons, lines and points that make up the components of the map (including the plan and/or cross-section(s)). For example if we have a many polygons on the plan depicting ‘CHALK’ all the attributes common to all of these would be stored in the legend tablet for chalk, so that the polygon attribute information vertex data structure on the plan and sections would carry these by means of one attribute cross-referencing to the legend, leaving only polygon-specific attributes in the polygon attribute information vertex data structure.

Optionally, the legend acts as a set of styles that can be copied for features including point, line and the dedicated information vertex data structures that store polygon attribute values, avoiding repetitious coding as each new feature is drafted.

Optionally, the displayed digital legend is created automatically to display only data present in an area of the plan selected for viewing.

Optionally, the digital legend comprises user-selectable components that control what is displayed in the plan.

According to a second aspect of the disclosure there is provided a computer program product comprising a database storing data comprising: a plurality of information vertex data structures each storing a plan location, one or more attributes of the space at that plan location, and a line identifier; said data enabling the generation of a digital plan representing a space and wherein a line is drawn on the plan between points corresponding to a plurality of information vertex data structures.

The computer program product may also include or implement any one or more of the features of the first aspect.

The disclosure provides tangible products in the form of digital maps. The digital map may be provided as an application and a customized database or data model. The application and the data structures/models set out in the disclosure can be loaded into the memory of a computing device and the application can be executed to provide advantageous effects as detailed herein. A computing system can be provided in which the various components of the disclosure are distributed between various different locations.

The computer program product may be stored on or transmitted as one or more instructions or code on a computer-readable medium. Computer-readable media includes both computer storage media and communication media including any medium that facilitates transfer of a computer program from one place to another. A storage media may be any available media that can be accessed by a computer. By way of example such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infra-red, radio, and microwave, then the coaxial cable, fiber optic cable, twisted pair, DSL, or wireless technologies such as infra-red, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. The instructions or code associated with a computer-readable medium of the computer program product may be executed by a computer, e.g., by one or more processors, such as one or more digital signal processors (DSPs), general purpose microprocessors, ASICs, FPGAs, or other equivalent integrated or discrete logic circuitry.

### DRAWINGS

The disclosure will be described below, by way of example only, with reference to the accompanying drawings, in which:

FIG. 1 shows a simplified example of a geological map showing both the bedrock and superficial deposits in a way that most represents the geology at the land surface;

FIG. 2 shows the equivalent map of the bedrock only, as if the superficial deposits were not present, giving a clearer if interpretative or conjectural impression of the bedrock geology;

FIG. 3 shows a simplified polygon and line drawing illustrating the vertex structure of polylines in an existing geographical information system;

FIG. 4 shows the simplified polygon and line drawing as it would be constructed using the method described in this disclosure; and

FIG. 5 shows the effect of progressive simplification of a complex line according to this disclosure (omitting the gVDS) as the scale of the drawing is reduced.

### DETAILED DESCRIPTION

1.1 What is GIS Software

Geographic Information System (or GIS) software is designed to capture, store, manipulate, display and analyze data that can be represented in a plan or map (referred to below as the GIS ‘plan’), by means of one or more drawings linked to data tables or a ‘geospatial’ database (referred to simply below as the ‘GIS database’). This information is captured and stored in one of two formats:
vector data, in which the world is captured and described as a series of objects by the digital coordinates that define the location and shape of each object along with additional information (herein referred to as attributes);
raster data comprising a grid of pixels each of which carries values that can be represented by a color to create a picture in the way that a digital photograph is stored.

Raster data provide a relatively inflexible fixed image but are useful within in the GIS environment for certain types of information. This format is used for scanned images of existing plans or maps or other published information that can then if required be traced to convert to vector format or used as a background for the display and visualization of other vector data.

Vector data are fully editable, such that the shape of the objects represented and the information captured about them can be changed by the user and new objects drawn and described. In this document we focus on aspects of vector GIS data and the way in which those data are captured and stored.

1.1.1 Vector Data—Attributes, Points, Lines and Polygons

In current GIS systems vector data are captured and stored as point, line or polygon (sometimes called area) objects, depending on the type of the features being represented and the scale of the GIS plan. Each object may be described by or link to various types of information, stored in the GIS database, including numeric, date and currency formats, text, and links to documents, photos, webpages, video, sound etc.

1.1.1.1 Attributes

Applicable to all types of vector data, attributes range from information required by the software, such as the geospatial location of each object, to any type of user specified information. Typically attributes are viewed and edited in a table format within which individual objects form the rows and attributes the columns.

Individual attributes can be visualized in a GIS plan drawing by the use of color, symbols and ornamentation. These may be set by the originator of the data or can be varied by the user to control the way in which the data appear in the plan.

Of importance here is that the attributes can only be assigned and stored for each whole object. This is necessarily the case for a point object, but to capture and represent variation in one or more attributes along a line or around or within a polygon it must be broken up accordingly.

1.1.1.2 Point Objects

A point is a single dimensionless location specified by a coordinate (e.g. longitude and latitude, coordinates in a national grid or some other system). The type of features represented by a point in a GIS map depends fundamentally on the map scale: for example, on a relatively large scale map a point may show the location of physical features such as a post box or telephone or, in a smaller scale map, much larger features such as a town or city. Commonly, however, a point is used to represent the location of a measurement or other data, for example a spot height or address. In the GIS software the point is usually displayed on the plan by a symbol that can be specified by the user to represent one of the attributes associated with that object.

1.1.1.3 Line Objects

Line objects may be used to represent features such as roads, rivers, railways or at smaller scale national or international boundaries or a coastline. Such lines are often referred to as a ‘polyline’ because curves are constructed graphically using short straight line segments, the location and shape of which are described by ‘ vertices’ that define the segments. Again the user can specify the line style, thickness color etc. used to represent a line on the map based on its attributes. The construction and use of polylines in geological plans is discussed in more detail below.

1.1.1.4 Polygon Objects

A polygon is simply an area defined by a closed line, representing for example a building, field or other property at a large scale or at smaller scales a town or city or even a country. There are more options in this case for visualization because the bounding line style can be varied as for a line and the area defined by the line can be filled by various ornaments and/or color.

1.1.2 Scale Dependency

It is evident that there is some scale dependence in the nature of the object drawn: a point on a topographical map representing a town on a small scale map showing a whole country must, at some arbitrarily defined zoom level, become a line (the town boundary) enclosing a polygon (the town itself); closing in further will reveal a network of lines (roads) and polygons (blocks of buildings) and so on.

1.1.3 Layers

As described above GIS data are typically made up from a number of separate vector drawings and raster image ‘components’. These constitute individual ‘layers’ when overlaid to create the GIS plan.

Point, line and polygon vector data are usually captured in different layers (depending on the product this may be a requirement of the software) but there may then be many layers within each of these classes both to assist in drafting but also to organize the data for use.

Layers can be viewed and edited independently or superimposed in any order in which case they can be turned on or off (made visible or not) or made variably transparent to achieve the required plan visualization.

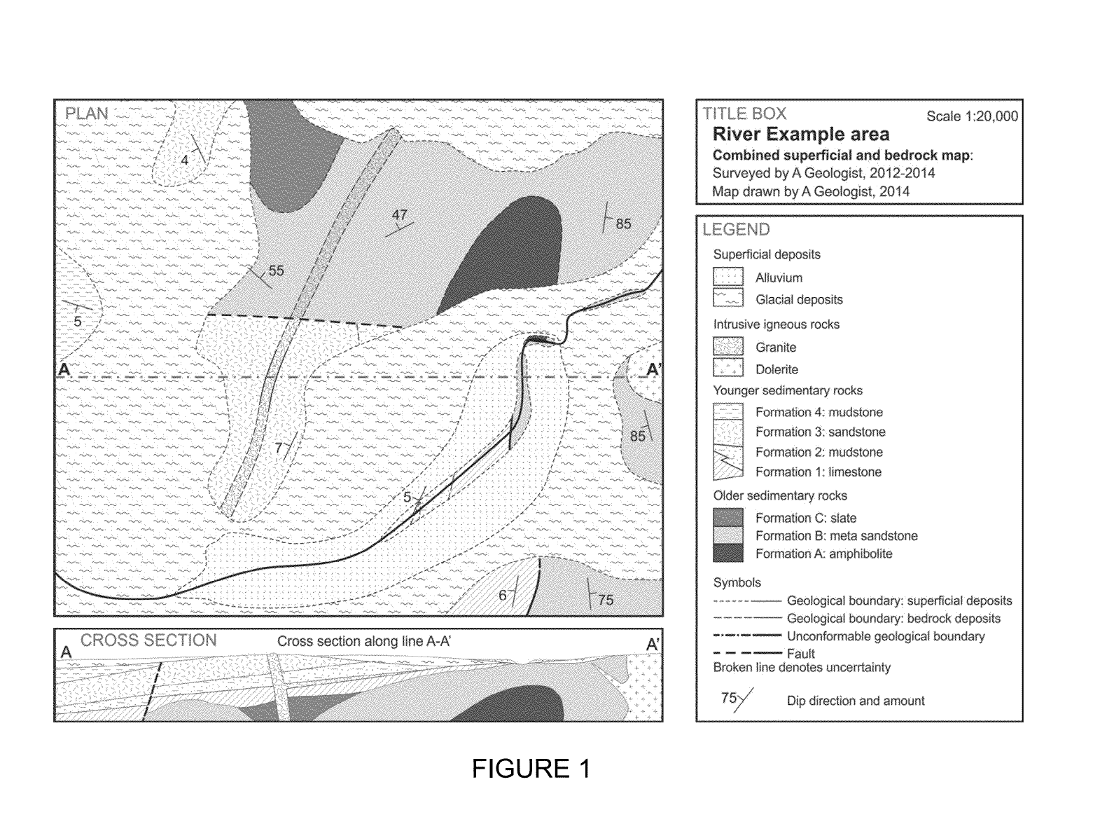

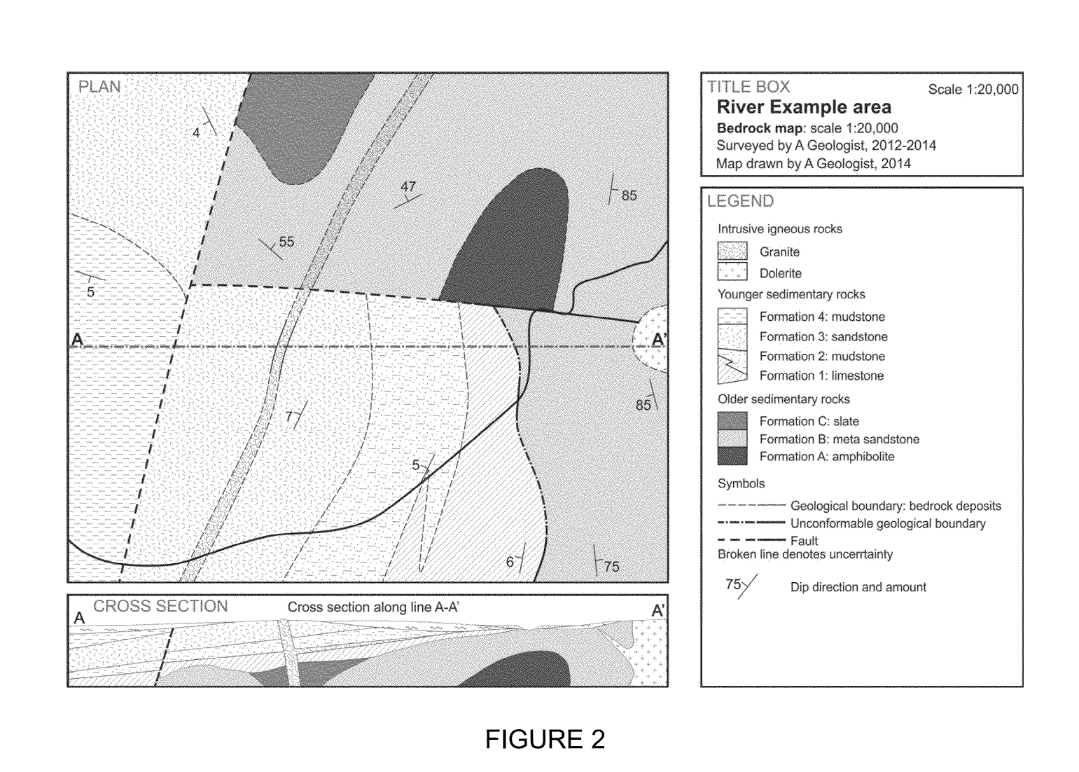

For example, the GIS equivalent of the plan component of FIG. 1 might comprise two point layers (the dip symbols and dip value labels), four line layers (the river representing digital topography, superficial and bedrock geological boundaries and faults) and two polygon layers (representing the superficial and bedrock deposits). If a published topographical map is available this can be scanned and included as a raster image layer. These layers are combined in one plan view in the correct order to create the required plan. From this the bedrock only plan (FIG. 2) can be created simply by turning off the superficial deposits lines and polygons layers, although it may be necessary to make the bedrock polygons layer partially transparent to view the geological plan on an underlying image of the topography.

1.2 GIS for Geological Mapping

Geological maps have evolved from a relatively simple map and key to more elaborate products comprising several parts (illustrated for example in FIGS. 1 & 2):

the map itself (referred to herein as the plan to distinguish it from the other components that make up the map as a whole) showing the geological composition and associated details of the area represented appropriate to the scale of the plan;

the legend or key providing a brief explanation of the colors and symbols used on the plan;

one or more generalized vertical section(s) (GVS) providing greater detail of parts of the geological succession(s) across the plan area; sometimes included within the key (e.g. the ‘Younger sedimentary rock’ succession in the legend in FIG. 1);

a brief description of the geological units represented, usually as part of the legend or GVS;

one or more cross sections illustrating the vertical dimension.

In addition various other types of components may be included to represent specialized information of relevance to the plan area or its geology. Each component is considered in turn below in the context of the present disclosure.

1.2.1 the Geological Plan

A geological plan is the main component of a geological map. Usually it is compiled for the land surface or the ‘rockhead’ (top of bedrock) surface, but in principal a geological plan can be created for any surface either geological or arbitrary such as flat surfaces at given depth levels.

The present disclosure provides a far higher level of data capture and functionality within the geological plan than has previously been possible for both the geoscientist creating the product but also for the user to allow semi-automated interrogation and visualization.

FIGS. 1 and 2 illustrate different aspects of the plan component: areas filled with ornament represent the extent of each deposit; varying types of line symbols representing different classes of geological boundary between them, often with a simple indication of confidence; one representation of point data is included as the symbols and values for the inclination (or dip) of the strata as might be measured where the bedrock is exposed at the surface.

In FIG. 1 the plan is drawn to represent the geological composition of the land surface including both the unconsolidated ‘superficial’ deposits and, where these are absent, the bedrock. Maps of this type are widely produced worldwide but where the representation of the bedrock geology is restricted to small areas it can be very difficult to understand. One solution has been to publish two ‘views’ as separate products: one showing the detail of the superficial deposits with little if any detail of the bedrock; the other (for example FIG. 2), showing the bedrock as if the superficial deposits have been removed (the rockhead surface).

The information represented in a geological plan varies with the scale of the drawing. If the area shown in FIGS. 1 and 2 is included in a smaller scale map, perhaps at one tenth the size, the subdivision of the two bedrock sequences may be omitted along with the many if not all of the symbols representing the dip of the strata. The boundaries of the superficial deposits may be simplified and small areas, for example of alluvium, may be omitted. The dyke might be omitted but if considered important its thickness may be exaggerated in order to include it at the smaller scale. This is considered further below under map generalization and line simplification.

It can be seen that the variable nature of a geological plan and the need for flexible presentation incorporating different elements of the geospatial data lend themselves to the GIS style of presentation. Consequently, GIS has been widely adopted for the creation and use of the plan component of geological maps. As described above, a geological map in GIS format is made up from many layers, each representing different aspects of the data or interpretation as point, line or polygon features as appropriate. However, for published products the GIS plan is typically produced at small scale and is limited to the principal line and polygon layers that make up the interpretation of the geology of the area represented.

1.2.1.1 Point Data in Geological Plans

Point data commonly represent observations and measurements at particular locations including links to additional information sources such as photographs, scanned paper records and publications via the internet. Certain types of point data are represented on traditional geological maps by various symbols to convey information important to the understanding and use of the map. For example the symbols and values showing the inclination of the strata on FIGS. 1 and 2 help the reader to understand the orientation of the geological units and their relationships to one another as well as providing information important for more specialized users.

Extant GIS products typically allow numerous attributes of varying types to be captured and applied to point data, although capacity for the visualization and investigation of this information in a geological context are poor. For example the orientated ‘dip’ symbols and labels shown on FIG. 1 are simple to replicate in GIS and can be set up in such a way that fewer symbols are seen as the scale of the plan view is reduced, but little capability exists to visualize and investigate these data in other forms of display. According to the disclosure, new facilities will be provided to allow complex visualization and interrogation of point data using a range of specialized graphical displays dynamically linked to the plan view within the GIS environment. For example point data attributes may be investigated or compared using appropriate graphical displays with simple capabilities such as linked selection and editing or modification of attribution.

1.2.1.2 Lines and Polygons in Geological Plans

A geological plan is required to classify and describe the type of geological material underlying every part of the land (often including the adjoining seabed) or other surface represented. As described above this is achieved by plan layers in which areas interpreted to be underlain by different types of deposit are represented by polygons of different color and or ornamentation as described in the legend. Additional information, for example about the nature of the geological boundaries between the rock units may be included as superimposed lines. The way in which the polygon boundaries and superimposed lines are drawn accurately in GIS is of particular importance to this disclosure.

Geological features may be mapped over hundreds of kilometers within which distance their character may change in significant ways, not least the degree of interpretation and uncertainty in respect of the location and nature of the boundary. On printed map products some variation can be represented by changing color or symbolization or added notes. Full description of geological lines (including polygon boundaries) can be only be achieved with attributes that have the facility to vary independently along the line. However, as described above, this is not possible in current GIS systems where attribution is only possible for each complete object. If variation in one or more attributes is required within or along the length of a feature it must be split into separate segments to form individual features within each of which all attributes are the same.

Lines are drawn digitally in GIS, as in other types of computer-aided design (CAD) software, as polylines by placing vertices that are linked as short straight line segments by the software to create the required line. The location and shape of the object is stored as the coordinates of the vertices within the GIS database.

Polygons are drafted and stored as the bounding line, although the software allows styles to be applied to the enclosed area as well as the line based on the attributes attached to each polygon. As with lines there is no facility in extant GIS products to identify variations in the classification of the area, only one classification may be applied to whole area of each polygon. For geological purposes the simplest attribution of polygons would typically capture the name and type of the deposit and its age. However, many other possible descriptors are possible. Existing datasets from different national geological mapping systems vary from three to over fifty attributes for each polygon, without any classification of confidence or accuracy which may be applied to many of these attributes in a comprehensive system.

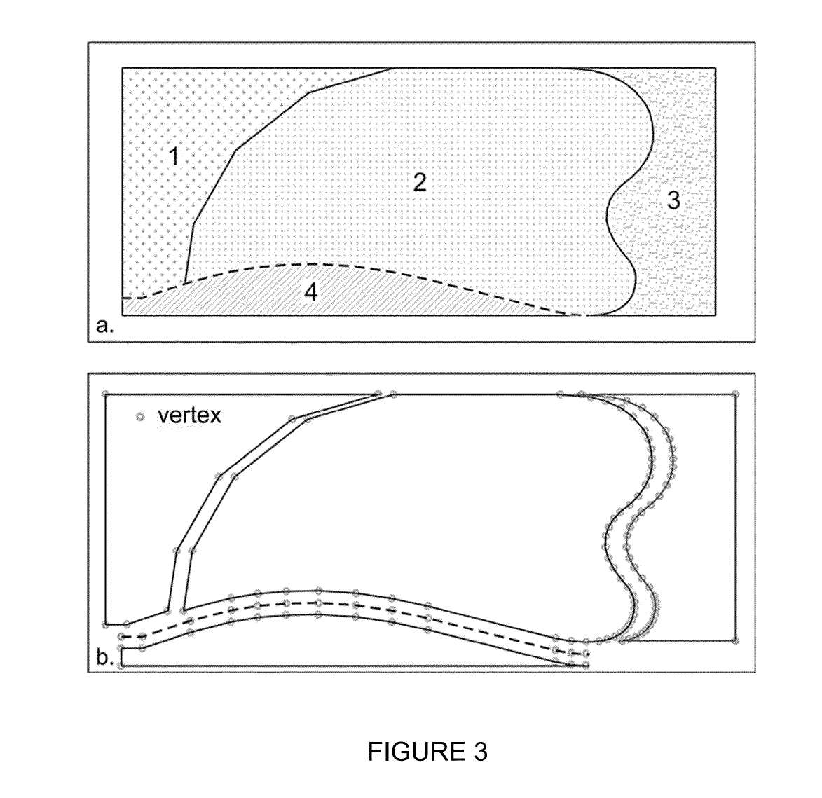

The structure and practical use of polylines in extant GIS systems is illustrated in simplified form in FIG. 3. Four adjoining polygon objects with one superimposed line object (the pecked line) are shown in FIG. 3a; an exploded view of the same drawing (FIG. 3b) shows the vertex structure of the lines and the way in which the vertices are repeated for each object.

It is seen In FIG. 3b that only the two end points are required to construct a straight line, such as around the margins of the drawing. Relatively few vertices can be used to define the location and shape of an angular line or the crude shape of a curved line such as that between objects 1 and 2. Depending on the tightness of the curves, many vertices may be required to make a curved or sinuous line appear smooth to the eye as can be seen from the other lines in the drawing.

Perception of a polyline as smooth depends as much on the scale of view as the way in which it is constructed. For example moving away from the page or zooming out to reduce the size of FIG. 1 (in effect reducing the scale at which it is viewed) eventually causes the angular line between polygons 1 and 2 to appear smooth. It is evident therefore that many more vertices are required to create the same curves in drawings for use at a larger scale of view. In good drafting practice, a curved line is drawn according to the largest scale at which it will be viewed, ensuring that it will appear smooth at any scale of view. However, if a line is highly convoluted it may then be too complex to be viewed at much smaller scale as discussed below under map generalization and line simplification.

FIG. 3 also illustrates that precise edge-matching of the adjoining polygons (without overlap or gap) and superimposition of any additional lines is achieved in extant GIS software by replicating the vertices in each adjoining or superimposed object, multiplying the data storage requirement as well as making drafting onerous because any change to one line has to be precisely replicated in any matching lines.

There are different ways of capturing polygons depending on the software used and the capability of the user. The simplest is to draw each polygon as its bounding line and classify it by means of attributes. However, the polygons must be drawn to abut precisely, without overlap or gap, requiring that two exactly superimposed lines, one for each adjoining polygon are stored. Such a boundary can be presented without further description or qualification when it can be read as a default stratigraphical or intrusive boundary as may be inferred from the description of the bounded rock units. Any other condition or any qualification (for example a faulted boundary) must then be represented by a superimposed line, again drawn to exactly match the polygon boundaries, and subdivided into separate features as necessary for description.

An alternative but less intuitive method is to draw a network of lines that are individually classified including the type of geological boundary represented. The software then automatically creates and displays the polygons as the plan is viewed. This method has the considerable advantage that each line only needs to be drafted once, rather than as two exactly superimposed lines as in the previous method. Any subsequent editing is also far simpler with only one line. In this method only line and point data are stored by the software, although for use in other GIS products it may be necessary to export the product in the polygon and line format.

To facilitate automated creation of polygons from a line network the polygon fill information can be included as part of the line attribution as discussed below (e.g. a line coded as bounding an area of alluvium or a segment of a line coded as the base of the outcrop of a given formation). An alternative existing method, is to use special ‘seed’ points placed within each polygon to carry the polygon attribute values. According to the disclosure, this form of attribution can be assisted by the software, e.g. the seeds being derived from the relevant part of the dynamic legend as described below.

1.2.1.3 Uncertainty and Accuracy

Most geological mapping involves a varying degree of interpretation or even conjecture, and therefore varying kinds and levels of uncertainty are implicit in both the lines and the polygon areas. Qualification and quantification of such uncertainty are a desirable, but at present an effectively unrealized aspect of geological maps.

As an example, it is evident from FIGS. 1 and 2 that in the areas covered by superficial deposits the interpretation of the bedrock and the detail of its mapping may be uncertain or conjectural depending on the amount of subsurface data that may be available. For example the fault in the left side of the cross section is not exposed within the plan area, its existence and its location on the plan may be entirely conjectural. To the left of the fault no relationship between formations 3 and 4 is seen within the plan area, consequently the detail of the younger sedimentary rock succession is also a matter of interpretation if not based on other information.

The cross section on FIGS. 1 and 2 represents a vertical slice through along the line A-A′ drawn on the plan. Such cross sections are usually drawn extending to several hundreds of meters if not several kilometers in depth and again may be highly interpretative. For example without the benefit of boreholes or other deep data, the thickness of the superficial deposits and the form of the pre-existing land surface at their base is a matter of supposition. Far more uncertain are the depth and form of the much older erosion surface between the younger and older sedimentary rock sequences. Whilst to some extent these details may be of academic interest, if they impact upon engineering and construction or the investigation and exploitation of natural resources they may become very important.

Such uncertainty is widespread in geological mapping because, with certain exceptions, it relies primarily on observations made at the land surface although, especially in temperate and polar regions, the materials that occur even at shallow depth may be variably even completely obscured. For example it can be seen from FIG. 1 that with a cover of soil and vegetation the amount of information available at surface, even in relation to the composition of the younger superficial materials aside from the deeper rock units, may be very limited. The nature of often quite variable superficial deposits is commonly inferred from the shape of the land surface and the soil. Very little information about the bedrock may be available at the ground surface, especially if little or no rock is exposed even where superficial deposits are thin or absent. Hence the different sequences and the relationships between them must be pieced together from usually fragmentary evidence obtained over a wide area, often with the aid of other information such as interpretation of fossils to constrain the age relationships.

Sub-surface data, from pits a few meters deep to shafts or boreholes tens or hundreds of meters deep provide very valuable information. Shallow excavations and boreholes are commonly associated with construction activity and hence can be are widespread in urban areas. However such data may not be systematically collected and lost. Even where available such investigations typically would not involve a geologist so the data can be of very variable quality and a considerable degree of interpretation is often required in its use. Deep cored boreholes are particularly important to elucidate the order of succession and thicknesses of units. These are more often examined and described in detail by a geologist but they tend only to be available in areas of mineral potential unless drilled for research purposes.

It is clear therefore that geology, even in the very near surface, can rarely be completely known or understood. A variable, sometimes substantial, degree of interpretation or conjecture is present in any form of geological description, including mapping. Unfortunately, the extent to which a geological plan is based on data, is interpretative or conjectural is rarely clearly evident from the map itself. Methods that allow quantification and representation of such uncertainty are an important element of this disclosure.

Printed maps commonly used three line styles to represent different levels of confidence (classified as known, uncertain and conjectural) in the mapped location of the lines. Similar qualification of uncertainty in GIS plans requires the addition of line styles and therefore complete replication of the polygon boundary lines classified (and therefore in extant products fragmented) by both boundary type and confidence.

This has significant implications for the size and complexity of the GIS data files relative to the information carried. Geological boundaries are commonly highly convoluted, requiring many hundreds or thousands of vertices to represent them in detail depending on the largest scale of the mapping. Nevertheless, all lines are replicated at least three times to achieve even the most basic level of information concerning the nature of the boundaries mapped and the confidence in their location (i.e. the minimum level of information provided by pre-GIS printed map products). The drafting and subsequent editing of lines must be carried out with considerable skill to ensure that this ‘topological’ exactitude is retained. Yet at best the products barely imitate the information carried by previous generations of paper maps.

Many other types of uncertainty exist in geological mapping; for example the nature of a boundary may be observed locally but elsewhere is interpreted; the orientation of the surface represented by the boundary may again be known locally but may essentially be guessed elsewhere; the parameters of such uncertainties can be quantified. In addition to uncertainties affecting the mapping of surfaces and lines, polygon areas incorporate different kinds of uncertainty. For example, does the deposit described actually occur over the entire extent (if any) of the area mapped or, conversely, that no different rocks occur within the area defined. Representation of such uncertainties is a major issue that has never been resolved but can be addressed by the use of the methods described below.

1.2.1.4 Vertex Data Structures

The present disclosure provides new methods by means of which multiple variable attribution of a line (referring in the following to both line and polygon objects) can be achieved using ‘vertex data structures’ (VDS) to carry attributes assigned to segments of the line. This will allow completely flexible description of a line by any number of attributes without requiring it to be split or replicated. A new GIS database structure will be provided to realize this method in practice.

Depending on the number and type of attributes, VDS have the potential to reduce GIS database file size compared with corresponding polygon and line data when duplication or triplication of the lines in necessary. However, multiple attribution of all vertices may create a very large GIS database files if the number of attributes required and the number of vertices is not managed effectively. As described above and illustrated in FIG. 3, a line can be drawn accurately, albeit relatively crudely, with far fewer vertices than are required to give the line a smooth, visually acceptable shape depending on the curvature and scale of view. Used to replace simple vertices, the number of VDS necessary to fully describe variation in the character of the line is likely to lie between these extremes. Consequently, the number of fully attributed VDS can be minimized by distinguishing two VDS types as follows:

Information vertex data structures (iVDS)—VDS along a line where some information is known, albeit with a degree of uncertainty (itself specified in the attribution).

Graphical vertex data structures (gVDS)—VDS along a line required only to give the line the desired shape. These may be manually drafted or, ideally, software generated.

Separation of these two types of VDS allows a line to be drafted and fully attributed relatively quickly using only iDVS. Automated line generation as the plan is viewed based on the iVDS only will also have a number of advantages, notably in terms of the GIS database file size as the gVDS will not be stored but also, as discussed further below, in that it facilitates a simple method of line simplification as the scale of view is changed.

In practice in a fully automated system the gVDS may be present only as system points and not individually visible or editable. If the automated line does not achieve the required shape additional iVDS may be needed with low confidence attribution. For use of the data in other GIS software the iVDS along with the gVDS at a particular scale will be exported as standard vertices.

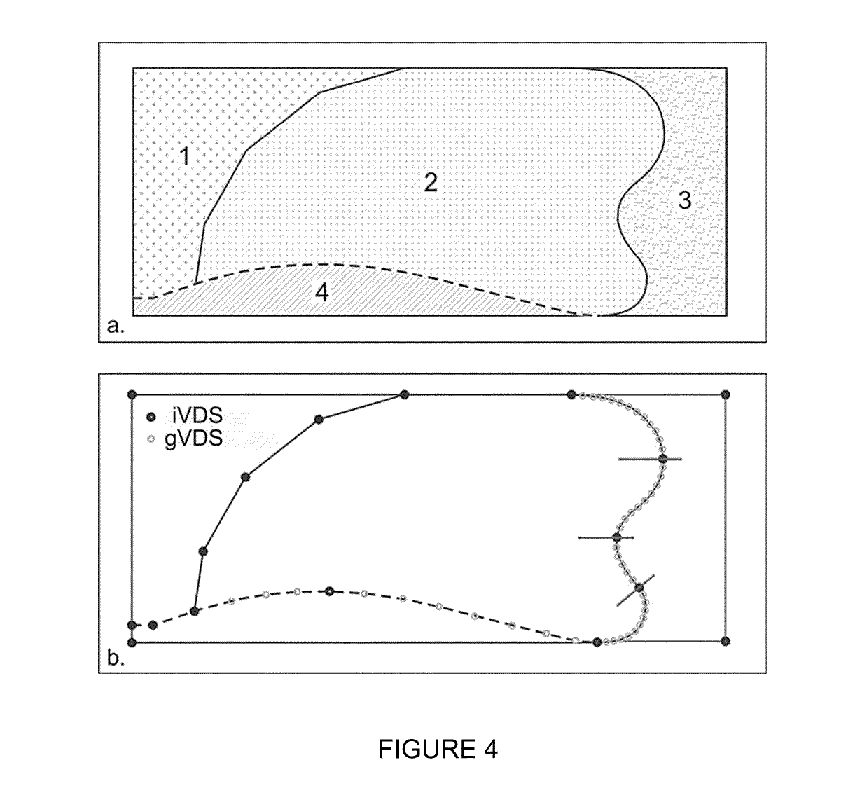

The use of VDS is illustrated in FIG. 4. In FIG. 4b however, no exploded diagram is possible as the lines exist as one set of VDS only. Relatively few iVDS constrain the required form with the lines between polygons 2, 3 and 4 smoothed by additional gVDS. Attribution of the iVDS distinguishes the common boundary of polygon 4 as being different from the other boundaries allowing it to be represented by a different line style without replication; any part of any of the lines including two or more iVDS can be distinguished in this way using variation in one or more of the attributes.

Even limiting attribution to iVDS, drafting long lines with many variable attributes could be laborious if each vertex has to be attributed as it is placed. Complex attribution will be facilitated in practice prior to, during and after line capture in several ways: common values (e.g. author, date, source, scale) can be set at the beginning of the session; specific values can be added at the start of or changed during drafting, either manually, copied from another iVDS in the drawing or from the digital legend or a pre-defined style list (which action would also add it to the digital legend). Semi-automated drafting tools that are sensitive to the information entered will request other information that would be expected in the context or suggest auto-completion options based on past data entries.

Once drawn, variation in attribution specific to small parts of a line can be edited retrospectively by selecting the necessary vertices and changing their attribution either as a group or individually (e.g. the line type may change along its length or pre-set default values (e.g. source or accuracy) may vary locally. Some attributes (e.g. a measured orientation on the surface represented) may apply to a single vertex and can also be added whilst drafting or if more convenient retrospectively.

Revision protocols can be implemented for editing to store versions that are modified or replaced. At some point in the drafting process (e.g. once a line is completed or upon completion of a plan version) the lines may be designated as a non-editable ‘finished’ version, if changes are required a copy will be made and vertices that are moved or added will carry new attribution accordingly. In this way it will be possible to trace the evolution of a line over time and to recall earlier versions if required.

For visualization, the user will be able to represent selected attributes limited only by the usual use of line style, color, thickness and ornamentation; other more complex visualization methods may be used where there are more attributes to be represented: numerical or text attributes may be displayed as labels adjacent to the line at the appropriate locations; more complete (user-specified) information may be provided by a ‘hover over’ tool that will display the attribute values from the nearest vertex as the tool is moved along the line.

Other forms of data visualization may also be envisaged. Whilst traditional visualization of fixed classes of locational certainty represented by different line types may still be desirable, far more detail can be provided if a measure of locational uncertainty either side of the line has been captured, for example ‘uncertainty bars’ drawn on the data vertices (e.g. FIG. 4 on the line between polygons 2 and 3).

Polygon fill may be created automatically from the line network using the iVDs attribution, in which case separate polygon layers need not exist independently within the database. Some layer types may require closed lines (e.g. superficial deposits that may exist in isolated areas) but this can be facilitated with appropriate drawing tools.

1.2.1.5 Plan Generalization and Line Simplification

Generalization of a geological plan raises several issues:

Complex lines (including polygon boundaries) have to be simplified, such that a highly convoluted line along a straight average course will eventually reduce to a straight line.

Small polygons must be deleted or exaggerated and surrounding polygon(s) modified accordingly.

Closely spaced small objects or points (represented as symbols) are progressively reduced in number, replaced by representative examples or deleted.

Management of small polygons or closely spaced objects can be achieved simply in a GIS plan by appropriate use of layers and layer visibility scale settings, allowing some layers to be automatically made visible or not as the scale of view is changed.

Line simplification is more challenging. Geological lines are captured at the largest scale of use, i.e. at their most complex, but may then require progressive simplification for use at smaller scales. At present this is usually addressed by manually redrafting simplified versions of the plan, even in GIS data, substantially increasing the time and effort involved in creating or editing a geological plan.

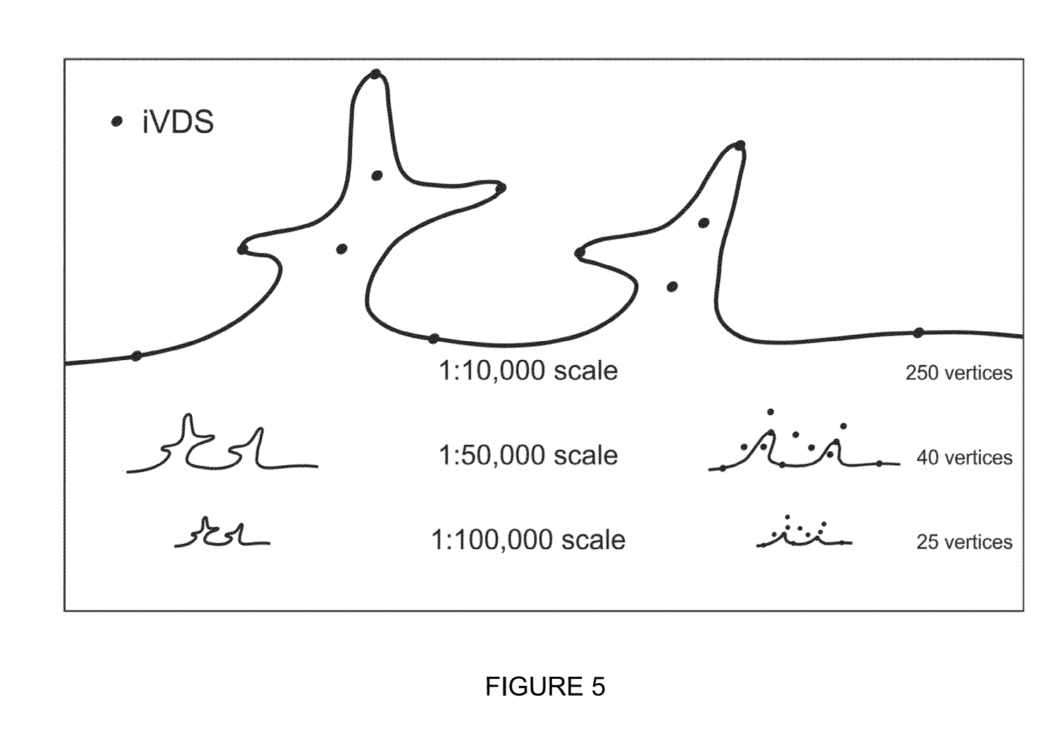

A simple system of automated line simplification is inherent in the use of VDS described above. It requires maximum and minimum scale attributes to be included in the iVDS and automated line generation. As illustrated in FIG. 5, lines are drafted using the iVDS as specified at the largest scale of use to give the required line shape when completed automatically. When the scale of view is reduced the line is recreated using the iVDS specified for that scale; preview may require in particular circumstances that iVDS are placed specially for use at smaller scale ranges if necessary to obtain a particular line shape. A more sophisticated version of this system may also utilize the locational uncertainty attribution of the iVDS. This concept is illustrated in FIG. 5 by segment of a complex geological boundary drafted at large scale (nominally 1:10,000). As seen to the left the line may be too complex for use at much smaller scale hence a simplified form of the line may be created as shown to the right. Not all of the iVDS are used to create the line as the scale is reduced, although iVDS have been included to constrain the shape at small scale.

If there is a requirement to use data created by line vertex attribution with other GIS products without the same capability, polygon layers can be exported in standard formats with matching line files for each attribute required, or a single line file with full vertex attribution and an add-on for the other product that will translate data created according to the principles of the present disclosure to the data format of the other product, so that the attributions can be imported as separate layers automatically.

1.2.1.6 Use of and Consistency with Topographical Mapping

The creation of topographical mapping is not usually part of a geological plan, this being ‘adopted’ from published topographical mapping at an appropriate scale (for use in GIS either as a raster image or digital data), although often aerial photography or satellite imagery may also be used in the plan preparation.

All map products vary in accuracy and detail hence with a geological plan being drafted to fit a particular topographical map there will some level of mismatch between the geology and the topography if the data are subsequently used on a different map, particularly one at a different scale. If this is a particular problem, automated plan creation based on iVDS will allow specialized versions to be created relatively simply to fit the main topographical products that may be used.

1.2.1.7 Specialized Plan Views

Consideration is given above to the traditional views of a geological plan and below we discuss how these may be dynamically linked to the legend and other components to explain and control the information provided. However, these views may be supplemented in GIS by additional layers that provide far more information where data are available: for example contours of the thickness of superficial deposits and height of the rockhead surface will be important for engineering applications. In coal mining regions plan layers showing the areas and depth of undermining with links to individual mine plans would be important for similar purposes. Such drawings may be prepared using the techniques described above, incorporating appropriate information regarding accuracy and uncertainty.

1.2.2 the Geological Legend

Geological maps must include a legend (for example FIG. 1) that provides an explanation of the colors, codes and symbols used in the plan along with other information such as stratigraphical and age classification and summary lithological description. If a generalized vertical section (GVS) is included the stratigraphical relationships and thickness are illustrated graphically.

A GIS legend is typically a rudimentary key to colors or symbols with a single descriptor based on one attribute that provides far less information in a less accessible manner than a typical geological map legend. As a consequence of which some providers of digital geological mapping also supply a conventional printed map legend/GVS.

1.2.2.1 the Dynamic Digital Legend

The present disclosure provides a dynamic digital legend component in support of the operation of VDS line attribution that will also provide a one solution to the creation of a high quality legend/GVS drawing using the GIS data and would have a number of additional benefits including acting as a ‘style pallet’ for plan drafting and attribution.

Digital legend creation will be facilitated by a new bespoke set of legend tools working in conjunction with the plan drafting tools to add elements automatically on first usage in the plan. More complex legend components such as a GVS may be created more freely by the geologist using standard drawing tools within the dynamic legend framework.

The present disclosure also allows that much of the information previously stored repetitively as attributes in the vector drawing files that make up polygon layers can be stored uniquely in the legend file, potentially representing a huge saving in file size and facilitating highly efficient editing as changes become necessary. These advantages are increased the more information is stored in the legend files. It is preferred that everything other than local values is stored in the dynamic legend file in order to achieve maximum efficiency, although this is not essential.

In creating a plan, as a new unit is added to the drawing or otherwise defined by splitting an existing unit it would first be added to and described within the dynamic legend rather than the plan; evolution of description or changes in stratigraphical relationships can be adjusted simply in this way as understanding of the stratigraphy develops over one or repeated surveys or as a result of continuous revision.

The dynamic legend acts when created this way as a set of ‘styles’ that can be copied for point, line and polygon seed features avoiding repetitious (and error-prone) coding as each new feature is drafted. The legend is referred to as ‘dynamic’ because it is not a static drawing that remains unchanged as the plan varies but rather that in use, the legend will be created automatically from the GIS database to represent only the units present in the plan area being viewed providing user-focused information.

The dynamic legend will also be used to actively control what is shown in the plan view. For example stratigraphical attribution on a geological plan is hierarchical with rock units usually being assigned potentially to named units at a Member, Formation, Group and Supergroup status. The legend will be created to illustrate the full intricacies of this classification but the level of detail required by any user may vary. Accordingly the dynamic legend will be used to control the information represented in the plan and other linked components such as the cross-section by turning on or off the detail of parts of the succession as shown both in the legend and the plan. Hence it may be that the user is interested in the detail of one part of the succession to Member level but other parts in far less detail; these settings can be simply made in the dynamic legend. Equally other aspects of the interpretation or other information represented on the plan may be superfluous and can be turned on or off as required.

1.2.3 Cross Sections

Vertical cross sections (e.g. FIG. 1 described above) are a critical part of a geological map as they illustrate the vertical structure and lateral variations in the succession, thickness and structure of the strata across the plan area. However they are laborious to draft and commonly only one section is drawn on a published map along a line selected to be representative but often influenced by the data available. Often it is not possible to show all the variation in one section and if as a map user your site of interest is not near the section then it may not be very helpful. Ideally, therefore, cross sections should be available as system generated products along any user selected line on the plan, but this requires exceptional levels of data and 3D modelling of every geological surface in the succession.

However, according to the present disclosure section drafting is assisted by incorporating the information that is available in the plan into a section drafting component that will allow the geologist to create many more ‘stock’ sections than previously (usually this is good practice in tandem with interpretation and drafting of the plan) and assist the experienced user to create bespoke sections as required. The ground surface profile can be drawn automatically along any line of section using digital ground level height data (digital or surface elevation models) where available. In areas with good borehole coverage it is also possible to provide a digital model for the rockhead surface allowing this to be created automatically on any line of section. Otherwise information from the point and line datasets can be represented along the geologist or user-defined section line, providing the intercepts of geological surfaces (lines on the plan), the inclination or dip of strata measured in exposures and profiles of boreholes within a specified distance of the line of section. Ultimately however, without a fully integrated 3D dataset some manual drafting will be required to complete the cross section using the drafting tools and ornamented using styles copied from the dynamic legend or plan.

For data use, cross-sections can be dynamically linked to the plan and legend components. Benefits such as moving the cursor along the cross section profile causing another to follow across the plan and highlighting a unit on the section repeating in the legend and plan will help users access and understand the information represented in both the plan and section more easily.

1.2.4 Graphs

A range of graph types are used to visualize and elucidate numerical geoscience data, ranging from simple x-y cross plots, histograms or box plots to specialized diagrams used for specific geoscience data types. Such techniques are widely used in data interpretation and help to unravel the stratigraphy and structure of areas of complex geology. They are particularly useful with chemical data for characterization or classification and discrimination, widely applied to igneous rocks but sometimes also useful for sedimentary rocks and exploration for mineral deposits. At present such graphs are rarely included on published geological maps. However their availability within the GIS mapping and interpretation package, wherein the data can be linked to sample locations, will be of significant benefit.

At present graphs are laboriously prepared by hand or by use of a range of different software packages depending on the data type, each with its own data format. The use of such software, in conjunction with a GIS database, to visualize and interpret data can be extremely tortuous: preliminary data classification in GIS, export via a common format for import to the plotting package, preparation of the required graph(s) then struggling to relate the graphical plot to the GIS plan to revise the classification, a process that can be repeated iteratively many times with complex data. Investigation of a first set of data may lead to collection of new data when the whole process needs to be repeated.

Availability of the graphs directly within the GIS has a number of advantages, including automatic updating to incorporate and changes made to the data or incorporate new data. Any number of graphs may be plotted for data analysis by simple selection of samples from the plan view and graph type. Selection tools operate across all components so a selection highlighted in one graph or on the plan is repeated in all. Additional datasets for comparison can be selected and added to the same plot with user specified symbolization for comparison. Selections can also be made using the polygons on the plans or even the legend to pick up all data, for example within a particular formation.

Other tools designed for use in the plan component also work in the graphical components. For example, tools may be provided to: zoom in and out of a graph as required (always retaining the axes in view), use drawing tools to annotate or create ‘fields’ within plots that can be saved for use with other data sets; georeference scanned images of published graphs within the graph window to allow simple comparison with other information and abstraction of published standard discriminant fields; export graph views to various standard image or drawing formats for publication.

A range of standard discriminant plots can be provided with the GIS.

1.2.5 Additional components

A published geological map will usually carry a range of information in text boxes and ‘inset’ maps presenting specialized views of the plan area at very small scale. A title box usually carries information about the authorship of the map sheet and may be supplemented by a diagram showing which areas have been mapped by the geologists concerned or areas where data have been taken from other sources such as scientific papers or PhD studies. According to the present disclosure this information will be carried in much greater detail within the plan through the vertex attribution, allowing a user to investigate if a critical line for example has been mapped through careful recent field investigation or copied from an old publication at very small scale. Often author information at this level is very useful because one quickly learns in any particular area that data quality may vary between individual authors.

Published inset maps may include summary data (e.g. major fault and fold structures), or representations of contributing information, commonly for example geophysical data. In digital datasets these can be included as parts of the main plan and identified and turned on or off using the legend.

The present disclosures provides a bespoke, GIS-based geoscience software system that may comprise several fully integrated and dynamically linked components to better serve both the geoscientist and data user communities. A bespoke database model coupled with a new method of data attribution allows the full variety and complexity of geoscience data and interpretation to be captured.

Visualization components, including a plan and other elements traditionally found on previous published map products can be supplemented with innovative and semi-automated ways of presenting the information more flexibly and in ways more convenient for information users.

A legend component will not only replicate the detailed information available in the legend of a printed map but facilitate new drafting and attribution capabilities and provide the user of the information with flexible control of the information displayed in all components. Other elements such as cross sections and specialized graphs will substantially assist the geologists creating the interpretation and make new visualization capability available to information users.

The GIS of the present disclosure allows geological interpretation to be kept up to date with data and scientific concepts instead of lagging up to 100 years or more behind. It will also facilitate rapid accurate survey of often low income countries that have little or no modern geological mapping at a useful scale by facilitate capability and capacity development amongst local geoscientists.

Various modifications and improvements can be made to the above without departing from the scope of the disclosure.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A digital map comprising:
a plurality of information vertex data structures each storing a location, one or more attributes of the space at that location, and a line identifier; and
a plan representing a space and comprising a line drawn on the plan between points corresponding to the locations of a plurality of information vertex data structures.

2. The digital map of claim 1, further comprising a plurality of graphical vertex data structures, each storing a location and a line identifier.

3. The digital map of claim 2, wherein a line is drawn on the plan between points corresponding to the locations of a plurality of information vertex data structures and a plurality of graphical vertex data structures.

4. The digital map of claim 2, wherein the number of graphical vertex data structures used in the construction of a line drawn on a plan varies with a scale of the plan.

5. The digital map of claim 2, wherein the line is plotted on the plan using the information vertex data structures and additional graphical vertex data structures are placed either manually or automatically according to a mathematical function.

6. The digital map of claim 1, wherein the information vertex data structures each store an attribute that defines a relative degree of importance or scale range within which they are applicable.

7. The digital map of claim 6, wherein a line drawn on a plan having a first scale is drawn between points corresponding to all the plurality of information vertex data structures, and a similar line drawn on a plan having a second scale is drawn between points corresponding to a selection of the plurality of information vertex data structures, wherein the second scale is smaller than the first scale and the selection of information vertex data structures is made on the basis of their stored relative degrees of importance or scale range classification.

8. The digital map of claim 1, wherein variations in a drawn line can be edited retrospectively by selecting the necessary vertex data structures and changing their attribution.

9. The digital map of claim 8, wherein previous versions of lines are stored so that the evolution of a line over time can be traced.

10. The digital map of claim 1, comprising a polygon drawn on the plan and created automatically from one or more lines drawn on the plan.

11. The digital map of claim 10, wherein polygon fill data is included as one or more of the attributes stored in an information vertex data structure.

12. The digital map of claim 10, wherein a dedicated information vertex data structure is provided which stores polygon attribute values or links to a legend structure.

13. The digital map of claim 12, wherein the plan location of the dedicated information vertex data structure is within the area of the polygon.

14. The digital map of claim 1, wherein one or more attributes of an information vertex data structure comprises a representation of confidence of the accuracy of one or more of the attributes stored in the vertex data structures.

15. The digital map of claim 14, wherein the representation of confidence of the accuracy of one or more of the attributes comprises a classification.

16. The digital map of claim 14, wherein the representation of confidence of the accuracy of one or more of the attributes comprises an integer value.

17. The digital map of claim 14, wherein the attributes for which a representation of confidence of accuracy is stored comprise one or more selected from a group including: x and y plane position, height, age, dip, thickness, younging (‘way up’), age of a geological unit, type of a geological unit, general confidence of a geological unit, type of a geological line, general confidence of a geological line, general confidence that a line represents a surface, age of a geological surface, dip of a geological surface, type of a geological surface, thickness of a geological surface, general confidence of a geological surface.

18. The digital map of claim 1, further comprising a digital legend data structure for displaying a digital legend.

19. The digital map of claim 18, wherein attributes of the space are stored in the digital legend data structure.

20. The digital map of claim 19, wherein the legend acts as a set of styles that can be copied for features including point, line and the dedicated information vertex data structures that store polygon attribute values, avoiding repetitious coding as each new feature is drafted.

21. The digital map of claim 18, wherein the displayed digital legend is created automatically to display only data present in an area of the plan selected for viewing.

22. The digital map of claim 18, wherein the digital legend comprises user-selectable components that control what is displayed in the plan.

23. A computer program product comprising a database storing data comprising: a plurality of information vertex data structures each storing a plan location, one or more attributes of the space at that plan location, and a line identifier; said data enabling the generation of a digital plan representing a space and wherein a line is drawn on the plan between points corresponding to a plurality of information vertex data structures.
